(19) United States
(12) Patent Application Publication
(10) Pub. No.: US 2006/0133433 A1
(43) Pub. Date: Jun. 22, 2006

(54) Efficient chamber pumped fiber laser and amplifier

(76) Inventor: Jason I. Alexander, San Jose, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/022,186

(22) Filed: Dec. 22, 2004

(51) Int. Cl. H01S 3/30; H01S 3/091; H01S 3/093

(52) U.S. Cl. 372/6; 372/72; 372/70

(57) ABSTRACT

Chamber pumped fiber lasers and/or amplifiers are provided having a high fiber packing efficiency. Chamber pumping a fiber entails substantially surrounding a doped region of the fiber with a chamber having reflective walls. Pump radiation introduced to the chamber that is not absorbed by the fiber is reflected back toward the fiber by the reflective chamber walls, thereby improving efficiency. The fiber packing efficiency η=2A_{f}/Aₛ, where A_{f} is the fiber side area and Aₛ, is the chamber surface area. In the present invention, η is greater than one and is preferably substantially greater than one. By increasing fiber packing efficiency, the pump power lost in reflection from chamber walls can be reduced, thereby increasing optical efficiency. Increased fiber packing efficiency can also reduce the sensitivity of optical performance to variation in pump wavelength.

### FIELD OF THE INVENTION

This invention relates to optical amplifiers and/or lasers having an optical fiber gain medium.

### BACKGROUND

Optical amplifiers and lasers are based on the phenomenon of stimulated emission in a pumped gain medium. A doped optical fiber is one kind of gain medium that has been employed in optical lasers and amplifiers. Since an optical fiber has a relatively unusual geometrical configuration for a gain medium (i.e., it is longer and thinner than most gain media), pumping an optical fiber presents unusual problems.

The most commonly employed optical fiber pumping approach is end-pumping. End-pumping entails coupling pump radiation into the fiber through one or both end faces of the fiber. As the pump radiation propagates along the fiber, the fiber is pumped. More precisely, one or more doped regions within the fiber (e.g., an Er doped region) absorb pump radiation and can then provide optical gain. Although end-pumping is a simple and commonly employed method, it has significant disadvantages for high-power applications. In particular, coupling high power pump radiation into a fiber is often limited by the optical damage threshold of the fiber end faces. Furthermore, end-pumping often leads to undesirable temperature non-uniformity within the pumped fiber, since the intensity of pump radiation is non-uniform within the fiber.

Dual-clad fiber lasers and amplifiers have been developed to improve high power end-pumping. A dual-clad fiber has a core, an inner cladding surrounding the core, and an outer cladding surrounding the inner cladding. The dual-clad fiber is designed such that the signal radiation is confined to the core, while the pump radiation is confined to the inner cladding and the core. Dual clad fibers can be pumped with higher optical power because the pump radiation provided to the end face does not need to be concentrated on the core of the fiber, but can cover the combined area of core and inner cladding. However, end pumping a dual clad fiber still entails concentration of the pump radiation within a relatively small area, which can lead to optical damage of the end face. Temperature non-uniformity is another disadvantage of dual-clad end pumping.

Accordingly, other approaches for pumping a fiber have been developed, which are referred to generally as side pumping approaches. Side pumping entails providing pump radiation to doped regions of the fiber through a side surface of the fiber as opposed to an end face. In side pumping of an optical fiber, special measures are usually required in order to improve pumping efficiency, since the doped region of the fiber typically has small lateral extent. Thus a side-illuminated fiber will typically absorb only a small fraction of the pump radiation incident upon it in a single pass. One approach for improving side-pumping efficiency is to include V-grooves in the fiber such that pump radiation incident from a side of the fiber is deflected to propagate along the length of the fiber, thereby increasing absorption efficiency. Such V-groove approaches are considered in U.S. Pat. No. 6,490,388 and U.S. Pat. No. 6,801,550. However, fabrication of such V-grooves in fibers can be costly.

Another approach for improving fiber side-pumping efficiency is referred to as “chamber pumping”. In chamber pumping, the fiber is placed within a chamber having reflective walls. Pump radiation is coupled into the chamber such that pump light passing through the fiber (i.e., unabsorbed pump radiation) is reflected by the chamber walls back toward the fiber. Repetitive reflections of unabsorbed pump radiation toward the fiber increase side-pumping efficiency. Chamber pumped optical fibers are considered in U.S. Pat. No. 6,052,392, U.S. Pat. No. 6,798,792, and U.S. Pat. No. 6,795,460. Chamber pumping of optical fibers is similar to chamber pumping of a solid state laser rod, e.g., as considered in U.S. Pat. No. 5,774,488 and in Ajer et al., Optics Letters 17(24), pp 1785-87, 1992.

However, the above examples of chamber pumped optical fibers have not considered methods of increasing pump absorption efficiency. Accordingly, it would be an advance in the art to provide efficient chamber pumped optical fiber lasers and amplifiers.

### SUMMARY

Chamber pumped fiber lasers and/or amplifiers are provided having a high fiber packing efficiency. The fiber packing efficiency η=2A_{f/A}ₛ, where A_{f} is the fiber side area and Aₛ, is the chamber surface area. In the present invention, η is greater than one and is preferably substantially greater than one (e.g., greater than about 1.1). By increasing fiber packing efficiency, the pump power lost in reflection from chamber walls can be reduced, thereby increasing optical efficiency. Increased fiber packing efficiency also reduces the sensitivity of optical performance to variation in pump wavelength. This advantage is often of great significance in practice (e.g., in Yb fiber systems).

### BRIEF DESCRIPTION OF THE DRAWINGS

FIG. 1 shows a prior art chamber pumped optical fiber.

FIG. 2 shows calculated fiber cross sections for the arrangement of FIG. 1.

FIG. 3a shows a fiber loop cross section according to an embodiment of the invention.

FIG. 3b shows calculated fiber cross sections for the example of FIG. 3a.

FIG. 4a shows a fiber loop cross section according to another embodiment of the invention.

FIG. 4b shows calculated fiber cross sections for the example of FIG. 4a.

FIG. 5a shows a fiber loop cross section according to yet another embodiment of the invention.

FIG. 5b shows calculated fiber cross sections for the example of FIG. 5a.

FIG. 6 shows a cutaway view of a chamber pumped optical fiber according to an embodiment of the invention.

FIGS. 7a-b shows cutaway views of a chamber pumped optical fiber according to another embodiment of the invention.

FIG. 8 shows output vs. pump for chamber pumped fiber lasers having 26, 30, and 32 loops of fiber in the chamber.

FIG. 9 shows threshold vs. wavelength for chamber pumped fiber lasers having 10 and 32 loops of fiber in the chamber.

FIG. 10 shows a schematic top view of a chamber pumped optical fiber apparatus according to an embodiment of the invention.

### DETAILED DESCRIPTION

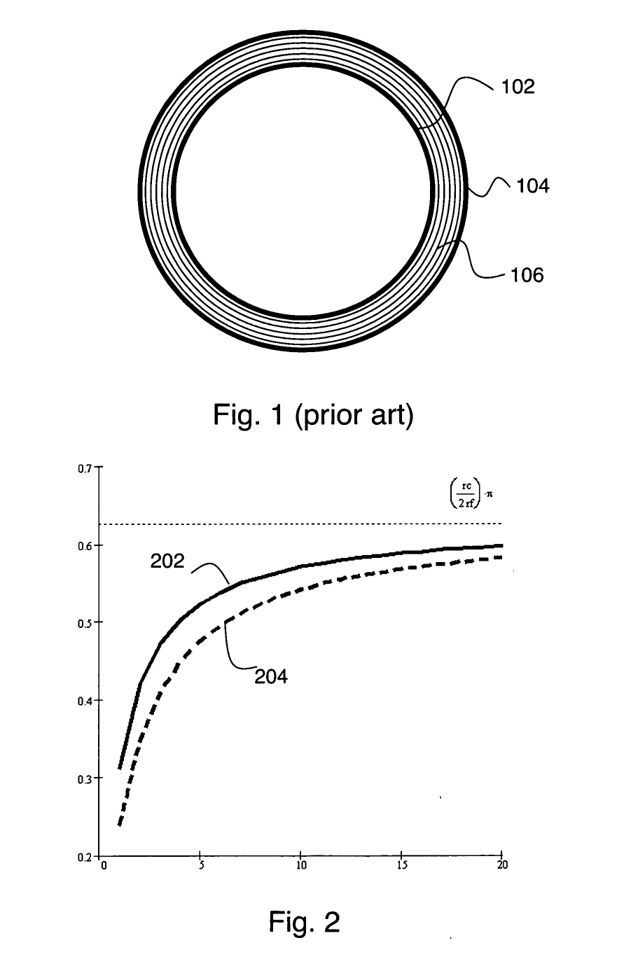

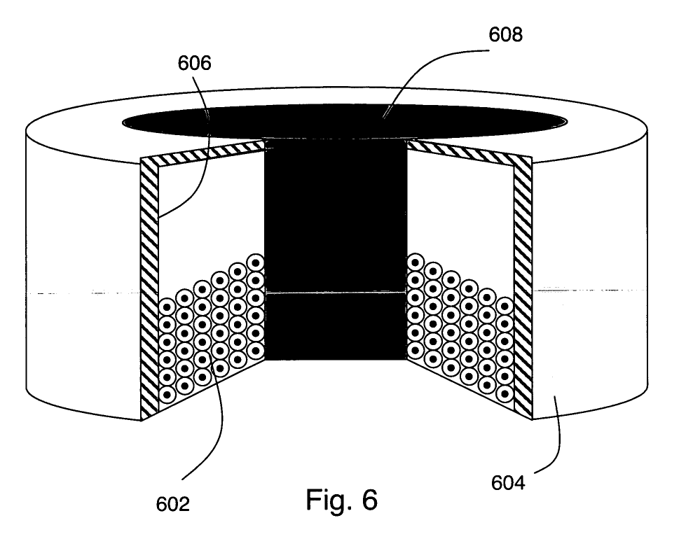

It is helpful to consider the geometry of prior art fiber chamber pumping more carefully. FIG. 1 shows an idealized top view of a prior art chamber-pumped optical fiber (e.g., as in FIG. 6 of U.S. Pat. No. 6,795,460). In this example, the fiber is arranged in a coil having a single annular layer. We define an area A to be the total fiber core side area in a chamber, and an area B to be the chamber wall area. In practice, areas A and B are estimated by idealizing the chamber and fiber geometry. For example, we assume fiber 106 on FIG. 1 is a circular fiber having radius r_{f} and having a circular core with radius r_{c}. The fiber core area A is given by

$$A = 2 π {r}_{c} {\sum }_{j = 1}^{n} 2 π [ {R}_{i} + ( 2 j - 1 ) {r}_{f} ] = 4 {π}^{2} {r}_{c} n ( {R}_{i} + {nr}_{f} ) \qquad ( 1 )$$

where Rᵢ is the radius of inner chamber wall 102, n is the number of fiber loops, and close packing of the fiber loops is assumed. Thus the radius of outer chamber wall 104 is given by Rₒ=Rᵢ +2nr_{f}. The chamber wall area is given by

$$\begin{matrix}B = 2 π ( {R}_{o}^{2} - {R}_{i}^{2} ) + 2 π h ( {R}_{i} + {R}_{o} ) \\ = 4 π ( 2 {nr}_{f} + h ) ( {R}_{i} + {nr}_{f} ) \\ = 8 π {r}_{f} ( n + 1 ) ( {R}_{i} + {nr}_{f} )\end{matrix} \qquad ( 2 )$$

where the second line follows from Rₒ=Rᵢ +2nr_{f}, and the third line holds when h=2r_{f}. The ratio A/B is less than πr_{c}/2r_{f}, and approaches this limit for large n (i.e., n>>1).

FIG. 2 shows plots of A/B vs. n for the geometry of FIG. 1 for a fiber having r_{f}=67.5 μm and r_{c}=25 μm. The solid line 202 pertains to a case where h=2r_{f}=125 μm, and the dotted line 204 pertains to a case where h=200 μm. The ratio A/B is seen to approach the limit of πr_{c}/2r_{f} in both cases, as expected from the above analysis.

The ratio A/B defined above is physically relevant because it gives the ratio of fiber core side area to chamber wall area. If this ratio is too small, pump radiation is mainly absorbed by the chamber walls, reducing pump efficiency. If A/B is too large, pump radiation may not be evenly enough distributed within the chamber to avoid the formation of “cold spots” where the fiber is absorbing instead of amplifying. For example, consider a hypothetical case where a thick coil of fiber is placed within a chamber having a single pump radiation port. If the single pass absorption of pump radiation by the fiber coil is sufficiently large, the amount of radiation reaching parts of the fiber coil facing away from the pump port may not be sufficient for transparency.

In order to better appreciate the present invention, it is helpful to define the fiber packing efficiency η=2A_{f}/Aₛ as a figure of merit, where A_{f} and Aₛ are the fiber side area and chamber area respectively. The motivation for introducing η is that it does not depend on the fiber core geometry, and is therefore indicative of the efficiency with which a fiber is packed into a chamber. In this application, “fiber side area” refers to the side cross-sectional area of the fiber, as opposed to the end face cross-sectional area of the fiber. Thus a circular fiber of length L and radius rf has a side area of 2Lr_{f}. For non-circular fibers having a longitudinal symmetry axis, the cross section plane defining A_{f} includes the axis and is selected to minimize A_{f}. For example, a length L of a fiber having an M by M square cross section has A_{f}=ML. The chamber area Aₛ, is the area of a closed surface S that includes the chamber reflective walls and entirely surrounds the doped region (or regions) of the fiber. The surface S is typically selected to have minimum area subject to the preceding two constraints, for convenience. In cases where the fiber within the chamber includes both doped and undoped fiber, the surface S surrounds the doped fiber region(s).

The calculation of the chamber wall area B above is an example of a calculation of Aₛ in a specific case. Similarly, the fiber core side area A is closely related to the fiber area A_{f}. More specifically, from the definitions above we have η=(A/B) (2r_{f}/πr_{c}) for circular fibers having a radius of r_{f} and having a circular core with radius r_{c}.

Thus the fiber packing efficiency η is less than one in the example of FIG. 1, and approaches one as n increases. The introduction of the figure of merit η allows a precise description of certain limitations of prior art chamber-pumped fibers. For example, U.S. Pat. No. 6,795,460 provides various examples of chamber-pumped fibers, and for each example in this reference providing sufficient information for an η estimate to be made, η is found to be less than one.

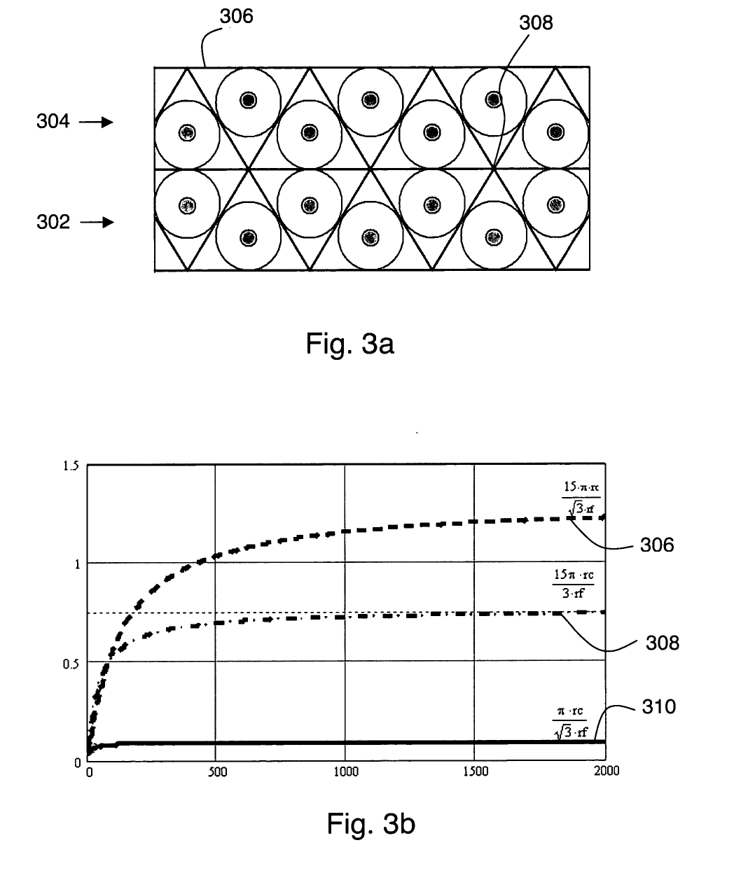

According to the present invention, chamber-pumped fiber lasers and/or amplifiers are provided having η greater than one, and preferably having η substantially greater than one (e.g., η greater than about 1.1), and more preferably having η greater than two. Such improvement of the fiber packing efficiency also provides a corresponding improvement of the cross-section ratio A/B. For example, the A/B ratio can exceed the limit of πr_{c}/2r_{f} found above for the configuration of FIG. 1. In one experimental embodiment of the invention, A/B of 0.38 was obtained for a fiber having r_{c}=19 μm and r_{f=}162.5 μm. The corresponding fiber packing efficiency η=2.1, consistent with the preceding characterization of the invention. There are various ways to achieve high fiber packing efficiency, some of which are considered in the following discussion of FIGS. 3a-b, 4a-b and 5a-b.

FIG. 3a shows a cross section view of a fiber arrangement according to an embodiment of the invention. The fiber loops of FIG. 3a are arranged on a hexagonal lattice. On FIG. 3a, there are two layers of fiber loops, 302 and 304. Each layer has 7 fiber loops. More generally, we can consider arrangements having m layers with n fiber loops per layer. The fiber loops of FIG. 3a are surrounded by a close-fitting chamber 306. The straight lines within chamber 306 are shown to clarify the geometry of this configuration, and thus do not correspond to any physical structure.

It is important to realize that the number of fiber loops apparent in a chamber cross section is typically not the number of fibers in the chamber. For example, a single fiber coiled in a chamber can have a cross section as in FIG. 3a. Alternatively, two or more fibers coiled in a chamber can also have the cross section of FIG. 3a. In such cases, the two or more fibers can have either different properties (e.g., different doping and/or core geometry) or the same properties. For example, single-mode fibers and/or multi-mode fibers can be used to practice the invention. The invention can be practiced with stripped fiber (where the protective polymer jacket is removed) or with unstripped fiber (where the protective polymer jacket is not removed). The use of unstripped fiber is preferable, because it is not as fragile as stripped fiber. When unstripped fiber is used, it is preferable for the protective polymer coating to be transparent to the pump radiation and resistant to optical damage at the pump intensity levels present within the chamber. The discussion focuses on the geometry of the fiber loops (as opposed to the details of the fiber or fibers) because this geometry determines the fiber packing efficiency η of the chamber, which does not depend on the number (or type) of fibers in the chamber.

For a single-layer (i.e., m=1) configuration having n fibers, we have
A=2πnr_{c}z
B=[2\sqrt{3}(n−1)+10]r_{f}z (3)
where z is the length of chamber 306 in a direction perpendicular to the plane of FIG. 3a. The length z is assumed to be sufficiently long that end effects have a negligible effect on the cross section ratio A/B. This approximation is referred to as the cylindrical approximation. Alternatively, the cross section of FIG. 3a can be regarded as a cross section through a toroidal chamber including a single-layer or multi-layer fiber coil. Such a toroidal chamber has no end effects, and therefore has about the cross section given by the cylindrical approximation, provided the toroidal radius is much greater than r_{f}.

In this embodiment, A/B approaches a limit of πr_{c}/sqrt(3)r_{f} as n increases. The corresponding limit on fiber packing efficiency is 2/sqrt(3), which is greater than one. The fiber packing efficiency (and cross section A/B) can be further improved by increasing the number of layers to m>1. For this more general case, we have
A=2πmnr_{c}z
B=[2\sqrt{3}(n−1)+6m+4]r_{f}z (4)
The limiting cross sections are mπr_{c}/sqrt(3) r_{f}(for n>>m) and nπr_{c}/3r_{f} (for m>>n). The corresponding limiting fiber packing efficiencies η are 2m/sqrt(3) and 2n/3 respectively, which can both be significantly greater than unity. Different results are obtained in the limits of large n and large m because the arrangement of FIG. 3a is not the same in the horizontal and vertical directions.

FIG. 3b shows plots of cross section (i.e., A/B) vs. total number of fiber loops in the chamber (i.e., nm) for a fiber having r_{c}=3 μm and r_{f}=67.5 μm. Line 310 shows A/B for a single layer of fiber loops (i.e., m=1), line 308 shows A/B for n=15, and line 306 shows A/B for m=15. The above cross-section limits are apparent on FIG. 3b. It is also apparent that it is preferable to design a fiber chamber to operate in the high n limit instead of the high m limit, to maximize cross section. Further improvements in cross section and fiber packing efficiency for this embodiment can be obtained by adding fibers to interstitial points such as 308 on FIG. 3a, where there is room to add a fiber without altering the chamber wall area.

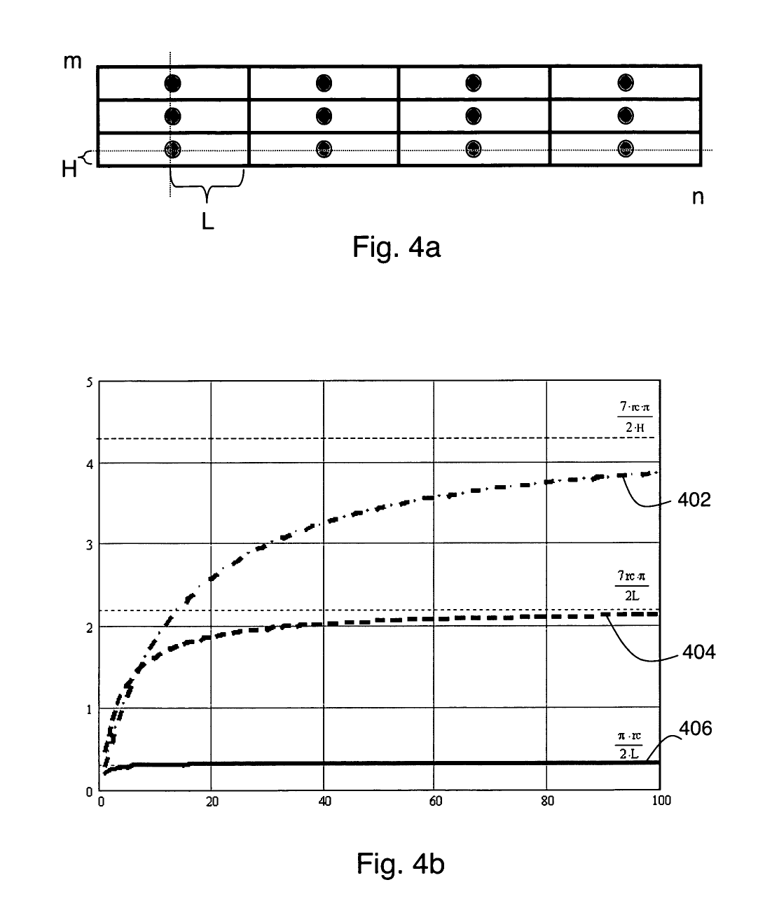

FIG. 4a shows a cross section view of a fiber loop arrangement according to another embodiment of the invention. The fiber of FIG. 4a is assumed to have a rectangular cladding with horizontal and vertical dimensions of 2L and 2H respectively. The fiber of FIG. 4a is arranged in a rectangular array of loops (m rows of n loops each) surrounded by a close-fitting chamber. In this embodiment we have

$$\frac{A}{B} = \frac{2 π {mnr}_{c}}{4 ( mH + nL )} \qquad ( 5 )$$

where the cylindrical approximation of Eq. 3 is assumed. The fiber packing efficiency η corresponding to the cross section of Eq. 5 can significantly exceed unity.

FIG. 4b shows plots of cross section (i.e., A/B) vs. total number of fiber loops in the chamber (i.e., nm) for a fiber having H=125 μm, L=250 μm, and r_{c}=50 μm. Line 406 shows A/B for a single layer of fibers (i.e., m=1), line 404 shows A/B for m=14, and line 402 shows A/B for n=14. It is apparent that it is preferable to design a fiber chamber to operate in the high m limit instead of the high n limit (since H<L in this example), to maximize cross section.

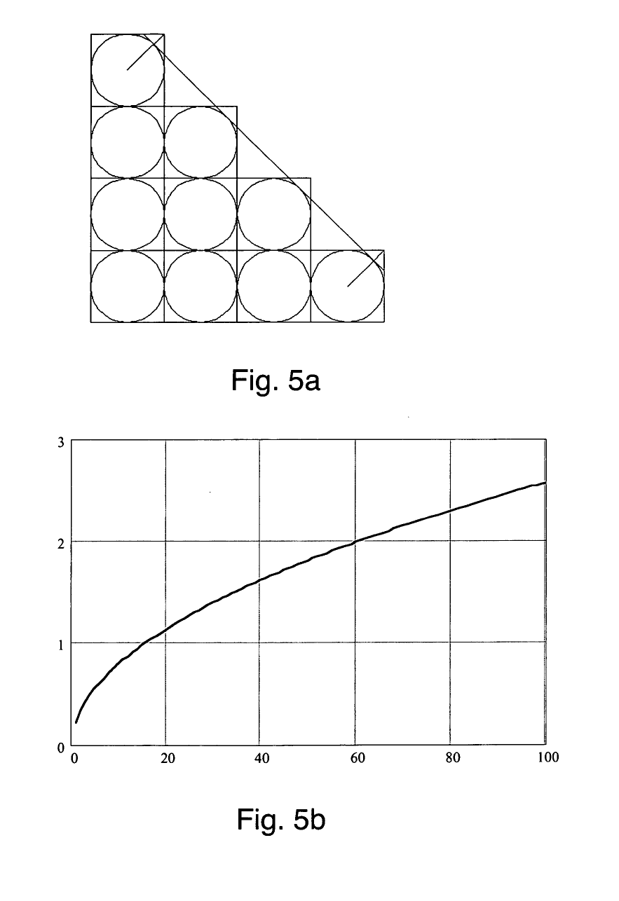

FIG. 5a shows an arrangement of fiber loops in a chamber according to another embodiment of the invention. In this embodiment, the fiber loops are arranged in a right isosceles triangle and surrounded by a close-fitting chamber. FIG. 5b shows the calculated cross section A/B vs. number of fiber loops for the arrangement of FIG. 5a. The cylindrical approximation is assumed. The fiber of this example is a circular fiber having r_{f}=67.5 μm and r_{c}=25 μm. On FIG. 5b, the cross section does not approach a limit as the number of fiber loops increases. In the examples of FIGS. 3a-b and 4a-b, limits were obtained when the number of fiber loops was increased while holding one dimension of the fiber loop array fixed. No limit is present in the example of FIGS. 5a-b because both dimensions of the fiber loop array increase as the number of fiber loops increases. The preceding discussion of FIGS. 3a-b, 4a-b, and 5a-b has focused on the fiber cross section A/B, the fiber packing efficiency η, and the relation of these key parameters to fiber packing geometry in some exemplary embodiments of the invention. The following discussion considers some physical implementations of fiber loop arrangements in a chamber according to the invention.

FIG. 6 shows an isometric cutaway view of a chamber pumped optical fiber according to an embodiment of the invention. Loops of fiber 602 are disposed within a chamber 604. Chamber 604 has reflective walls 606 facing the fiber loops 602. Fiber loops 602 are arranged within chamber 604 such that the fiber packing efficiency η is greater than one, and preferably substantially greater than one, and more preferably greater than two. However, it is also preferable that the fiber packing efficiency not be too high. Excessive fiber packing efficiency can lead to non-uniform pumping of the optical fiber such that not all doped portions of the fiber are pumped to transparency or beyond. This consideration is especially relevant in three level laser systems (e.g., as in Er doped fibers). In practice, an art worker will be able to balance these two considerations to select an appropriate η for a specific laser or amplifier design.

Chamber 604 is preferably a metal chamber such that reflective walls 606 are reflective metallic surfaces. Suitable surfaces include aluminum, gold-coated aluminum or silver-coated aluminum. Reflective walls 606 can be either polished or unpolished, since specular reflection is not required to practice the invention. It is preferred for walls 606 to be highly reflective (i.e., reflectance>0.9, more preferably>0.98) at the wavelength (or wavelength range) of the pump radiation provided to the chamber. Cooling of chamber 604 and fiber loops 602 can be provided by passing a heat exchange medium (e.g., a liquid such a water or a gas such as air) through a central member 608 of chamber 604 to facilitate heat flow away from the pumped fiber loops.

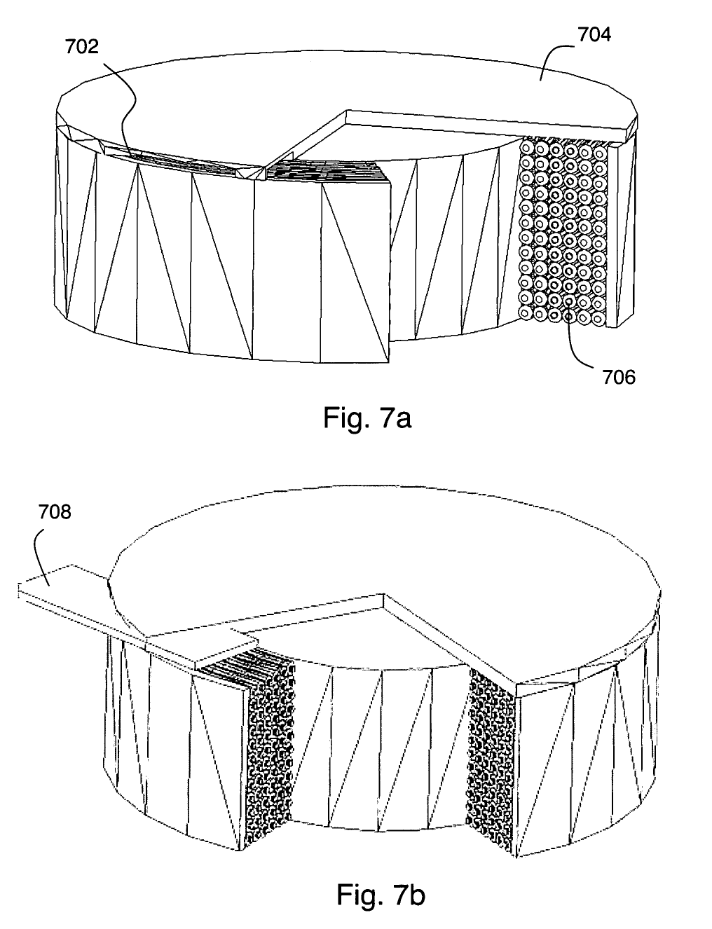

FIGS. 7a and 7b show cutaway views of chamber pumped fibers according to other embodiments of the invention. On FIG. 7a, fiber loops 706 are contained within chamber 704. A pump radiation input port 702 is also shown. Preferably, the area of the pump radiation input ports is a small fraction of the reflective wall area, to reduce the amount of radiation emitted from the chamber toward the pump radiation source through the port (or ports). More precisely, A_{w}/Aₛ is preferably >0.8 and is more preferably >0.9, where A_{w} is the area of the reflective chamber walls, and Aₛ is the area of a closed surface surrounding the doped region(s) of the fiber as discussed above.

FIG. 7b shows a pump radiation source 708 inserted into port 702. Pump source 708 can be any source providing sufficiently intense radiation at the appropriate wavelength (or wavelengths) to pump the fiber in the chamber to provide optical gain. Suitable sources include laser diodes, arrays of laser diodes, flash lamps, arc lamps, sunlight, or any combination thereof. Source 708 can be disposed outside the fiber chamber (as shown on FIG. 7b) or can be disposed inside the fiber chamber. If source 708 is inside the fiber chamber, then provision of a pump radiation input port (or ports) is not necessary. If source 708 is outside the fiber chamber, pump radiation can be delivered to pump input port 702 in any convenient manner (e.g., by fiber coupling and/or by direct coupling).

In contrast to many other fiber pumping approaches, chamber pumping does not require expensive pump coupling optical elements. In most cases, chamber pumping requires no pump coupling optical elements at all. For example, a laser diode array placed in close proximity to port 702 will efficiently couple light to chamber 704. There is no need to collimate the highly diverging radiation typically emitted by such sources. Beam divergence can even be beneficial, since it tends to even out the intensity distribution of radiation within chamber 704.

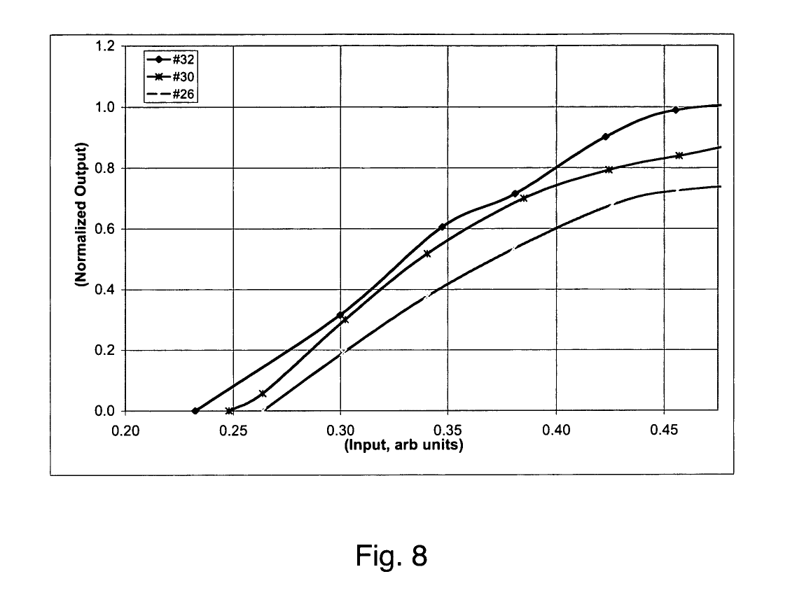

FIG. 8 shows measured optical output vs. optical input for a chamber pumped fiber laser. Three different curves are shown, corresponding to 26, 30, and 32 loops of fiber within the chamber. The chamber has the same dimensions for all three cases. As the number of fiber loops increases, the threshold decreases. Also, for a fixed pump input power that is above threshold, the output power increases as the number of fiber loops increases. The results of FIG. 8 demonstrate an advantage provided by efficient fiber chamber pumping according to the invention, since adding loops of fiber to a fixed chamber amounts to increasing the fiber packing efficiency η.

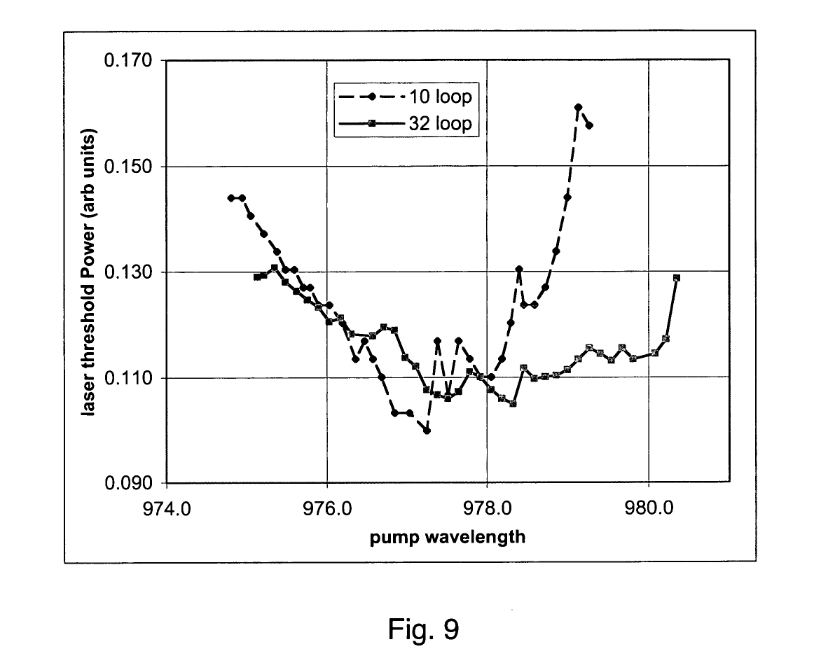

FIG. 9 shows measured threshold vs. pump radiation wavelength for a chamber pumped fiber laser. Two curves are shown, corresponding to 10 and 32 loops in the chamber. The chamber is the same for both cases. The sensitivity of the threshold to wavelength is seen to be much less for the 32 loop case than the 10 loop case. Thus increasing fiber packing efficiency η in accordance with the invention can also provide reduced sensitivity to pump radiation wavelength. This advantage is often of great significance in practice (e.g., in Yb fiber systems).

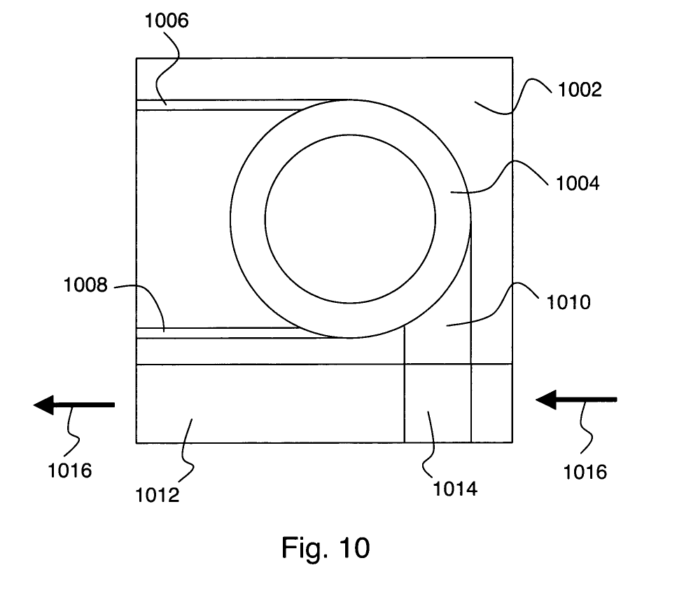

FIG. 10 shows a schematic top view of a chamber pumped fiber laser (or amplifier) in accordance with an embodiment of the invention. A chamber block 1002 includes a generally toroidal chamber 1004 within which loops of fiber (not shown) are efficiently packed (i.e., having η>1). Chamber block 1002 also includes fiber input and output ports 1006 and 1008, which provide clearance for input and output optical fibers (not shown) between the fiber loops in chamber 1004 and the exterior of chamber block 1002. A pump radiation input port 1010 is included in chamber block 1002 to enable coupling of pump radiation to chamber 1004. Chamber 1004 preferably has a greater depth (i.e., in a direction perpendicular to FIG. 10) than ports 1006, 1008, and 1010, in order to reduce radiation loss through the ports. The interior surfaces of port 1010 are preferably reflective, in order to reduce pump loss.

A pump source 1014 is affixed to a pump block 1012, which in turn is attached to chamber block 1002. Thus, radiation from pump source 1014 passes through pump input port 1010 and enters chamber 1004 to pump the fiber loops therein. In this embodiment, pump block 1012 is cooled by the flow of a coolant (shown schematically as 1016). Preferably, chamber block 1002 is in thermal communication with pump block 1012, so that blocks 1012 and 1002 are both cooled by coolant flow 1016. In this preferred embodiment, the pump source and chamber are in thermal communication with a common heat sink, which simplifies design. However, in this and other embodiments of the invention, it is preferred for the optical pump source (e.g., laser diodes) to be electrically isolated from the pump chamber. Methods for providing thermal communication and electrical isolation simultaneously are known in the art, and such methods are suitable for practicing this embodiment of the invention.

The preceding description has been by way of example as opposed to limitation, and so the invention can also be practiced according to many variations of the preceding cases. For example, embodiments of the invention include optical amplifiers where the optical fiber has a signal input and a signal output, and pumping the fiber in a chamber provides optical gain between signal output and signal input. Embodiments of the invention also include fiber lasers, where an optical resonator including a chamber-pumped, doped region of fiber is provided such that laser oscillation occurs. In the preceding examples, pump radiation is shown entering the chamber along a direction that is substantially tangential to the coil of fiber within the chamber. It is also possible to practice the invention by providing pump radiation to the chamber along a direction that is substantially radial relative to the coil of fiber within the chamber. In most cases, tangential pumping will be preferable, since it tends to provide improved intra-chamber pump uniformity compared to radial pumping.

What is claimed is:

1. An optical gain apparatus comprising:
a) an optical fiber having a doped region;
b) a pump chamber having a reflective surface facing and substantially surrounding the doped region of the fiber;
c) an optical pump source providing pump radiation to the chamber to optically pump the doped region of the fiber;
wherein a closed surface including the reflective surface and completely surrounding the doped region of the fiber has a surface area Aₛ;
wherein the doped region of the fiber has a fiber side area A_{f};
wherein a fiber packing efficiency η=2A_{f}/Aₛ is greater than one.

2. The apparatus of claim 1, wherein said optical fiber is arranged in a coil within said chamber.

3. The apparatus of claim 2, wherein said coil is a single-layer coil or a multi-layer coil.

4. The apparatus of claim 2, wherein said pump radiation is input to said chamber tangentially or radially with respect to said coil.

5. The apparatus of claim 1, wherein said fiber packing efficiency η is substantially greater than one.

6. The apparatus of claim 1, wherein said fiber packing efficiency η is greater than about 2.

7. The apparatus of claim 1, wherein said reflective walls have a wall area A_{w} >0.8 Aₛ.

8. The apparatus of claim 1, wherein said closed surface has substantially minimal area.

9. The apparatus of claim 1, wherein said optical fiber has a signal input and a signal output, whereby the apparatus provides an optical amplifier.

10. The apparatus of claim 1, further comprising an optical resonator including said doped region, whereby the apparatus provides a fiber laser.

11. The apparatus of claim 1, wherein said reflective walls include a metal surface.

12. The apparatus of claim 1, wherein said reflective walls include aluminum, gold-coated aluminum or silver-coated aluminum.

13. The apparatus of claim 1, wherein said reflective walls provide a reflectance greater than about 0.9 for said pump radiation.

14. The apparatus of claim 1, wherein said optical pump source comprises a laser diode, an array of laser diodes, a flash lamp, an arc lamp, sunlight or any combination thereof.

15. The apparatus of claim 1, wherein said optical fiber comprises single-mode fiber or multi-mode fiber.

16. The apparatus of claim 1, wherein said chamber is gas-cooled or liquid-cooled.

17. The apparatus of claim 1, wherein said chamber and said optical pump source are each in thermal communication with a common heat sink.

18. The apparatus of claim 1 further comprising an additional fiber having an additional doped region, wherein the additional doped region is disposed substantially within said pump chamber.

19. The apparatus of claim 1, wherein said optical pump source is electrically isolated from said pump chamber.

20. A method for providing optical gain, the method comprising:
a) providing an optical fiber having a doped region;
b) providing a pump chamber including a reflective surface facing and substantially surrounding the doped region of the fiber;
c) providing pump radiation to the doped region of the fiber from an optical pump source;
wherein a closed surface including the reflective surface and completely surrounding the doped region of the fiber has a surface area Aₛ;
wherein the doped region of the fiber has a fiber side area A_{f};
wherein a fiber packing efficiency η=2A_{f}/Aₛ is greater than one.
